(19) United States
(12) Patent Application Publication
(10) Pub. No.: US 2020/0111126 A1
(43) Pub. Date: Apr. 9, 2020

(54) Entertainment style digital display device system

(71) Applicant: Romona S. Woodard, Jacksonville, FL (US)

(72) Inventor: Romona S. Woodard, Jacksonville, FL (US)

(21) Appl. No.: 16/154,858

(22) Filed: Oct. 9, 2018

(51) Int. Cl. G06Q 30/02

(52) U.S. Cl. CPC G06Q 30/0265; G06Q 30/0261

(57) ABSTRACT

A method for displaying and outputting data and information viewable from the outside of a motor vehicle, the system comprises: a projector unit; a display panel in the form, or polymeric film panel implemented inside or a motor vehicle; a processor coupled to a non-transitory computer readable(memory), the processor reads information from, writes information to the memory; a wireless communication interface for receiving and sending signals; an application or software program connected to and in communication with the processor, the application comprises a plurality of software modules which include instructions executable by the processor, the modules may be implemented in programmable hardware devices such as programmable gate arrays, programmable array logic, programmable logic devices, graphics processing units, and the like, the processor processes information and executes instructions from the memory and/or software modules; the instructions include information for displaying data in the form of visible alphanumeric text, messages, images, animated images.

### CROSS-REFERENCE TO RELATED APPLICATIONS

U.S. Patent Application no. 2014/0028980 A1, published in the name of Othmer; U.S. Pat. No. 7,478,492 B2, issued in the name of Madonia; U.S. Pat. No. RE 36,930, issued in the name of Houten et al.; U.S. Pat. No. 7,148,935 B1, issued in the name of Ho et al.; U.S. Pat. No. 6,266,589 B1, issued in the name of Boies et al.; International Publication no. WO 2013/101046 A1, published in the name of Intel Corp.; U.S. Patent Application no. 2011/0258895 A1, published in the name of Rodgers, Jr.; U.S. Pat. No. 7,057,811 B2, issued in the name of Bruegl et al.; U.S. Pat. No. 5,281,985, issued in the name of Chan;

### STATEMENT REGARDING FEDERALLY SPONSORED RESEARCH OR DEVELOPMENT

THE NAMES OF THE PARTIES TO A JOINT RESEARCH AGREEMENT: Attorney P. Jefferey Martin performed a patentability search in 11/2015

INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB): Click here to enter text

STATEMENT REGARDING PRIOR DISCLOSURES BY THE INVENTOR OR A JOINT INVENTOR

I Romona Woodard known as inventor, has disclosures my business plan to investors and Organizations with The Small Business Administration, University of North Florida Small Business Development Center and Score for business needs which has described the services and products my invention will offer.

### BACKGROUND OF THE INVENTION

### (1) Field of the Invention

The special software program will develop a new coding that will allow brands to enter the program as a live character playing a role based on the inputted information from the account. Unlike other software programs that has previous created animated people and creatures. The device will allow customers to display the display's on a device in the vehicle, home or business window. Unlike previously viewed only from smartphones, IOS, lab tops and or desktops.

### (2) Description of Related Art Including Information Disclosed Under 37 CFR 1.97 and 1.98

Gifs, Game Consoles, animated Characters, computer entertainment

### BRIEF SUMMARY OF THE INVENTION

For decades people have personalized their vehicle and business windows, we have a new methodology for strategic and dynamic information sharing. This will allow members to advertise specific national and international brands using a new entertainment style display system that will work in your home, business and vehicle. This will reduce or even eliminate the high cost of a Billboard and Outdoor advertising. The services are a very special application program for all smartphones and tablets that support IOS or Android. The product is a brand-new innovative display device that will create a social media outlet other than the use of a mobile phone device, a tablet, or laptop/desktop computer. This will create a new market place for all brands on the internet.

The application programs will allow brands to enter a digital world with characteristics features showing strengths over opponents by way of fans participation. The system will offer levels of entertainment displays. Unlike Gifs, the seconds of display will allow the brands to demonstrate a celebratory reaction toward the defeated opponent. All brands and more will represent the name and history that the brand stands for, but as a character illustrated with abilities and power. Customers will be able to purchase brands online creating a market for brands online that does not exist today, Christmas trees will magically decorate itself for the holidays digitally. Example, I can purchase a coke a cola brand online with out purchasing a soda. Or even if I purchased a coke product a special discount will be offered to apply to discount the purchase of the display. The system will offer levels of displays.

### BRIEF DESCRIPTION OF THE SEVERAL VIEWS OF THE DRAWING(S)

FIG. 1 shows:

Receiving: able to receive over air special alert message, Bluetooth (level 4), Wi-Fi capable. Motion detection for auto on/off. A built-in rechargeable battery, automatic shut off timer Screen Display Width Ratio: 16:9 default—adjustable to 5×7, 8×10, etc. Positive Projection Range: 10″ to 3′ zoomable Lamp Brightness: 200 lumens Batter: Built in 3.7 V 9000MA plus alternate Power Adapter: DC 5V 3 A or US Power Plug: AC100-240V, 50/60 Hz Contrast Ratio: 5000:1 Uniform brightness: >80% CPU: Proprietary Operating System: Android (latest) Internal memory: 32 GB with alternate Micro SD Card slot supporting up to 256 GB Image Formats Supported: Gif, jpeg, jpg, bmp, png, etc. Video support: MPEG-1, 2, 4 Wi-Fi connectivity 2.4/5G Adobe Flash Supported: 11+ Bluetooth: 4.0 HDMI: 1.4 Audio output support: MP3, MP4, WMA, WAV Remote Control via smart phone or tablet devices utilizing Bluetooth. Device ID Code Brightness Setting (built within the application) Power on/Reset button Size: 4″×6″×1.5″ (W×L×H)

### DETAILED DESCRIPTION OF THE INVENTION

very special application program for all smart phone or tablets (supports either IOS or Android) that will allow our customers to privately advertise their specific personality brands using an “online billboard ad” like advertising function on a new entertainment style display system. This display system will be a monthly service program with several levels from a Basic FREE to a FULL ALL BRANDS access and will work in your car, home or business. When used in a business location it would be like a specialized window display ad that is easily modified. That same message can be broadcasted throughout the local area via “shared displays” from our user base. The application will allow the user to create a custom designed message or logo and it can allow you to choose a national/international brand logo or message from our proprietary database and allow members to broadcast their logos or message ads using a very innovative and brand-new social media outlet other than their mobile phone device, tablet and/or desktop/laptop computers. The Device Purpose is to provide a portable DLP device that will allow the user to display a static or active mini personal message or a custom logo or a corporate logo of your favorite team (Full account membership activation may be required) onto the Business, Homes and Vehicles window. This display is viewable by individuals when the vehicle is parked or by those driving alongside. Special alert messages such as weather conditions or amber alerts can also be forwarded to devices located in the territory so designated by local and state authorities. This device will mount in a unique way onto the interior roof of your car depending on which window(s) you wish to project your display message. Can also display the vehicles tag, registration and insurance information as was as the operator's driver's license when and if required by authorities.

Physical Characteristics. Manufactured in a metal or carbon fiber unit measuring approximately 4×6×1 inches. Color: Flat Black body. Display Full Color Lenses: 3 Located on the bottom for scanning, projection, zoom. Adjustable Display time frames from 5 seconds to fixed. Lens covers to shut down certain specific displays.

Operating System: The device will have the capability to connect to the application software program via Wi-Fi for firmware updates. The application software programs will comprise a plurality of custom modules that include instructions executable by the processor, the modules will be implemented into a programmable hardware device. The device will contain a memory circuit board programmed to execute instructions for displaying visible data within the scope of the area.

The device will have the capability to measure the area for projection using a laser scan to check the parameter. Once the scan is completed the measurements for the width and length in the diameter of the area will be collected and stored to the device. This will allow the device to project a display inside the parameters and allow reverse imaging.

The display will use technology to show a motion hologram picture from the application program to project images downwards and into and around the measurements to create the display screen. (Projection is determined by the device location) This technology will use the prism causing the LCD to reflect within its parameter. The display will be transparent with the ability to dissipate. This will allow viewers to see the display from the opposite side of the window in a proper viewing angle.

It will also be motion sensor to allow the display to move into various movement stages based on information from motion detection.

The device will have the abilities to offer a fan mode selection, which will allow a vehicle that is in a slow traffic area to display under a certain miles per hour according to the motion sensor detection

1. A method of making an entertainment style digital device system, comprising:
a) Forming a software program coding to create national and international brands into action characters
b) Forming a device to display the images from the program allowing customer to use the window of their home, business and vehicle.
c) Putting together a and b to form the system
